(19) United States
(12) Patent Application Publication
(10) Pub. No.: US 2004/0217522 A1
(43) Pub. Date: Nov. 4, 2004

(54) Dual extruder, tri-layer system

(75) Inventors: Matt Crider, York, PA (US); Mike Kelly, Red Lion, PA (US)

Correspondence Address: VENABLE, BAETJER, HOWARD AND CIVILETTI, LLP, P.O. BOX 34385, WASHINGTON, DC, 20043-9998, US

(73) Assignee: Graham Packaging Company, L.P., York, PA (US)

(21) Appl. No.: 10/426,970

(22) Filed: May 1, 2003

(51) Int. Cl. B29C 49/00

(52) U.S. Cl. 264/540; 264/173.16; 425/532

(57) ABSTRACT

A method is provided for forming a parison for use with a blow mold machine for producing blow molded containers. The method includes supplying exclusively a first material from a first extruder to an extrusion head, the first material being for forming a portion of the parison, and supplying a second material from a second extruder to the extrusion head, the second material being for forming a portion of the parison. The method also includes forming the parison in the extrusion head, the parison having a tubular shape with an outer layer of the first material, a middle layer of the second material and an inner layer of the first material. The first material has a lower tendency to adhere to parts of the blow mold machine than does the second material.

### BACKGROUND OF THE INVENTION

The invention relates to a container molding process. More particularly, the invention relates to systems and methods for improving production of a wheel type blow-mold machine.

One commonly used wheel type blow-mold machine produces continuous extrusion blow-molded plastic containers. It will be understood that to form a polyolefin continuous extrusion blow-molded plastic container, a parison can be heated in an extruder, captured by a mold, and blown in the mold. Specifically, to form the cavity of the container, a parison can be extruded into the mold and as the mold comes together, a pneumatic blow pin, for example, can pierce the parison and blow the parison up against the walls of the mold. The mold typically contains flash pockets above and below the cavity in the mold to capture the excess of the parison that is forced above and below the cavity. When the parison is blown inside the mold, it is forced into the flash pockets and portions of the parison must adhere together. The excess flash can then be cut away from the container after it is ejected from the mold.

The parison often contains material that has previously been heated and processed one or more times. For example, the excess flash referred to above can be ground up and then remelted in the extruder. Other recycled material such as, for example, post-consumer recycled material, can also be used in the parison. For simplicity, all such regrind and other recycled material will collectively be referred to as recycled material in this application. This recycled material can have different properties than virgin material that is being heated for the first time. An important difference that can exist between recycled and virgin material is that recycled material can tend to stick to machine parts more readily than virgin material.

### SUMMARY OF THE INVENTION

Various parts in blow mold machines require regular cleaning to remove material build-up. Such parts include, for example, the die pin and bushing used to shape the parison. This material build-up can cause machine malfunctions and can reduce the quality of the containers produced. One solution to this problem is to use all virgin material in producing the containers. However, the use of recycled material, as opposed to using all virgin material, can greatly reduce the cost of the finished container. As a result, a certain amount of regular cleaning of the machines is considered worth while in order to allow the use of recycled material.

The invention allows the use of recycled material while also limiting or eliminating contact between the recycled material and particular parts of the blow mold machine. This is achieved by using two extruders, one containing only virgin material and one containing recycled material. The extruder that contains recycled material may, in addition, contain virgin material. The two extruders supply the material such that the parison is formed in three layers: an outer layer of virgin material, a middle layer of recycled material and an inner layer of virgin material. This composition allows only virgin material to come in contact with parts of the mold machine, thus reducing the amount of material build-up on the machine parts.

Another advantage of the invention is that the maximum material temperature can be reduced by using two extruders instead of one extruder. A reduced maximum material temperature increases the number of times material can be recycled before the quality of the material is negatively impacted. For example, heating a color additive to a higher temperature can cause breakdown of a low melting carrier used as a substrate for the pigment. In addition, a reduced maximum material temperature requires less cooling to reach the required temperature for release from the mold. Higher temperature can also require reducing flow rate to prevent slippage. Operating at a lower temperature would thus allow for higher output flow rates.

Embodiments of the invention provide a method of forming a parison for use with a blow mold machine for producing blow molded containers. The method comprises supplying exclusively a first material from a first extruder to an extrusion head, the first material being for forming a portion of the parison, supplying a second material from a second extruder to the extrusion head, the second material being for forming a portion of the parison, and forming the parison in the extrusion head, the parison having a tubular shape with an outer layer of the first material, a middle layer of the second material and an inner layer of the first material. The first material has a lower tendency to adhere to parts of the blow mold machine than does the second material.

Other embodiments of the invention provide a parison supplying apparatus for use with a blow mold machine for producing blow molded containers. The apparatus comprises an extrusion head for forming a multi-layered parison, a first extruder for supplying exclusively a first material to the extrusion head, the first material being for forming a portion of the parison, and a second extruder for supplying a second material to the extrusion head, the second material being for forming a portion of the parison. The extrusion head forms the parison in a tubular shape with an outer layer of the first material, a middle layer of the second material and an inner layer of the first material. The first material has a lower tendency to adhere to parts of the blow mold machine than does the second material.

Still other embodiments of the invention provide a blow mold machine for producing blow molded containers. The machine comprises an extrusion head for forming a multi-layered parison, a first extruder for supplying exclusively a first material to the extrusion head, the first material being for forming a portion of the parison, a second extruder for supplying a second material to the extrusion head, the second material being for forming a portion of the parison, and a plurality of molds for forming the containers from the parison. The extrusion head forms the parison in a tubular shape with an outer layer of the first material, a middle layer of the second material and an inner layer of the first material. The first material has a lower tendency to adhere to parts of the blow mold machine than does the second material.

### BRIEF DESCRIPTION OF THE DRAWINGS

The invention is explained below in further detail with the aid of exemplary embodiments shown in the drawings, wherein:

FIG. 1 is a plan view of an example of a blow mold machine in accordance with the invention;

FIG. 2 is an elevation view of the blow mold machine shown in FIG. 1;

FIG. 3 is a side view of a parison produced by embodiments of the invention;

FIG. 4 is a sectional view along section line IV-IV of the parison shown in FIG. 3; and

FIG. 5 is a sectional view along section line V-V of the parison shown in FIG. 4.

### DETAILED DESCRIPTION OF THE INVENTION

The invention is explained in the following with the aid of the drawings in which like reference numbers represent like elements.

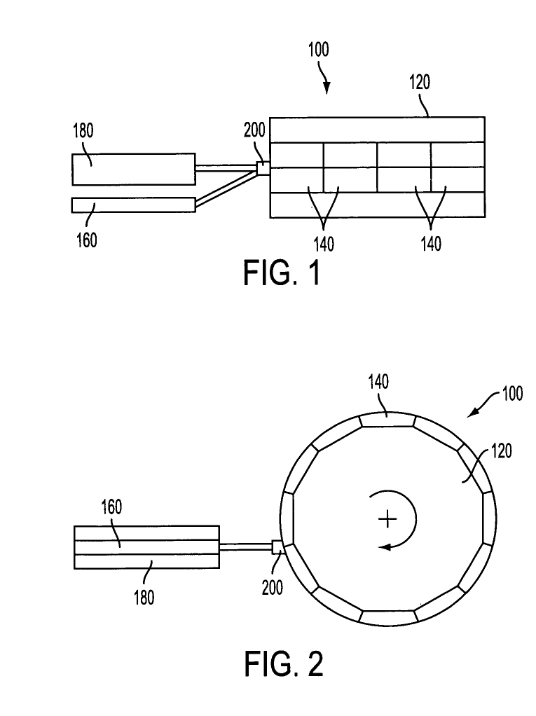

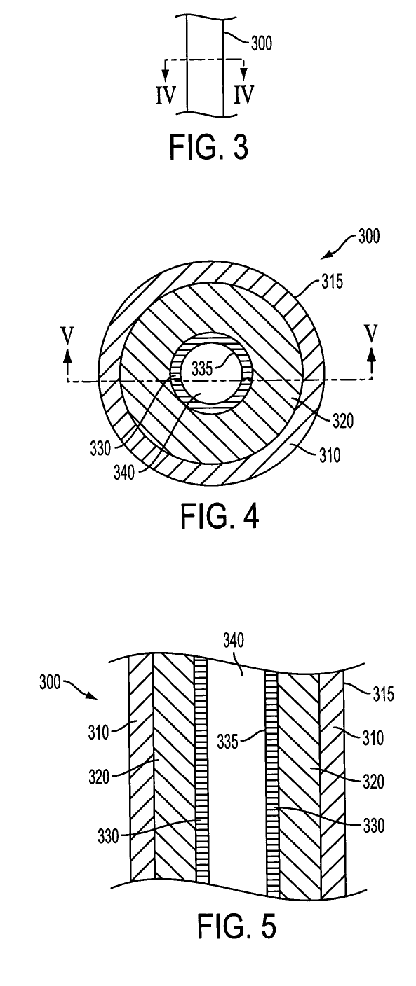

FIG. 1 shows a blow mold machine 100 in accordance with particular embodiments of the invention. Blow mold machine 100 has a mold wheel 120 on which a plurality of molds 140 are mounted. In this example, mold wheel 120 has twelve two-piece molds 140. It is noted, however, that any appropriate number of molds can be used. In this example, mold wheel 120 rotates clockwise, as shown in FIG. 2. As molds 140 move with the rotation of mold wheel 120, they close on a parison 300 (shown in FIGS. 3-5) that is produced at extrusion head 200 (described later). Parison 300 is then blown by, for example, an injected gas up against the inside surfaces of mold 140. As mold 140 continues in its rotation, the container formed by mold 140 cools and is, ultimately, released from mold 140 and the molding procedure begins again.

Recycled material is often used in the production of extrusion blow molded plastic containers. This recycled material can include pre-consumer material and post-consumer material. Pre-consumer material can include material that has been melted, molded, trimmed away as waste and reused. Post-consumer material can include containers that have been used by consumers and then recycled. While post-consumer material can include impurities, both pre-consumer and post-consumer material have been subjected to multiple heating cycles during the molding process. As can be imagined, recycled material can contain material that has been heated and cooled several times. With multiple heating cycles, the material can breakdown causing it to adhere more readily to parts of the blow molding machine. This increased stickiness causes deposits to form on various parts of the blow molding machine, resulting in machine shutdowns for cleaning. In addition, material that has been recycled multiple times can build up a resistance to accepting coloring agents. For at least the reasons discussed above, it is preferable to use virgin material in the blow mold machine to minimize downtime for cleaning and to minimize the amount of coloring agents needed to obtain a desired color. However, recycled material can be less expensive than virgin material and the use of recycled material may be required by law or desirable for other business reasons.

The invention provides a solution to the dilemma presented by the positive and negative aspects of using virgin material versus recycled material. A multi-layered parison is provided by using a first extruder 160 containing only virgin material and a second extruder 180 containing recycled material. Second extruder 180 can contain only recycled material or a combination of recycled and virgin material. The material from first extruder 160 and the material from second extruder 180 are combined in extrusion head 200 to form a parison 300 as shown in FIGS. 3-5.

FIG. 4 shows a section of parison 300 along section line IV-IV shown in FIG. 3. Parison 300 has an outer layer 310, a middle layer 320 and an inner layer 330 forming a tube around a void 340. Outer layer 310 and inner layer 330 are made of the virgin material produced in first extruder 160 while middle layer 320 is formed from the material produced in second extruder 180. As parison 300 moves through various parts of blow mold machine 100, only an outer surface 315 of outer layer 310 and an inner surface 335 of inner layer 330 contact parts of blow mold machine 100. Because outer layer 310 and inner layer 330 are made from virgin material, parison 300 is less likely to stick to, and form deposits on, any parts of blow mold machine 100 with which parison 300 comes into contact.

By providing a parison having only virgin material on its outer surfaces and having recycled material between those surfaces, a cost effective parison that avoids the maintenance problems associated with a parison comprised completely of recycled material is provided.

In the example shown in FIGS. 4 and 5, the overall thickness of parison 300 has the following composition: 20% outer layer 310, 70% middle layer 320 and 10% inner layer 330. These percentages are just one example of an appropriate composition of parison 300. It will be noted that other percentages can also be used.

Another advantage of the invention is the reduction in maximum material temperature as compared with a single extruder apparatus capable of the same production rate. For example, by adding a second extruder, the rotational speed of the first extruder can be reduced, resulting in the material in the first extruder achieving a lower maximum temperature. A lower maximum temperature of extruded material is beneficial for at least two reasons. First, less cooling is required to reduce the temperature of the molded container to the temperature needed for release from the molds. Second, a lower maximum temperature reduces the extent of the adverse properties discussed above associated with heat cycling of recycled material.

For at least the reasons discussed above, the invention provides a parison that can decrease the costs of, and increase the production rate of, extrusion blow molded plastic containers.

The invention has been described in detail with respect to preferred embodiments and it will now be apparent from the foregoing to those skilled in the art that changes and modifications may be made without departing from the invention in its broader aspects. The invention, therefore, is intended to cover all such changes and modifications that fall within the true spirit of the invention.

What is claimed is:

1. A method of forming a parison for use with a blow mold machine for producing blow molded containers, the method comprising:
supplying exclusively a first material from a first extruder to an extrusion head, the first material being for forming a portion of the parison;
supplying a second material from a second extruder to the extrusion head, the second material being for forming a portion of the parison, and
forming the parison in the extrusion head, the parison having a tubular shape with an outer layer of the first material, a middle layer of the second material and an inner layer of the first material,
wherein the first material has a lower tendency to adhere to parts of the blow mold machine than does the second material.

2. The method of claim 1, wherein the first material and the second material are polyolefin.

3. The method of claim 2, wherein the first material is virgin material and the second material is recycled material.

4. The method of claim 3, wherein the outer layer of the parison is approximately 20% of the thickness of the parison, the middle layer of the parison is approximately 70% of the thickness of the parison, and the inner layer of the parison is approximately 10% of the thickness of the parison.

5. The method of claim 1, wherein the first extruder has a smaller production rate than the second extruder.

6. The method of claim 5, wherein the first extruder is a 3.5 inch extruder and the second extruder is a 6 inch extruder.

7. The method of claim 1, wherein the outer layer of the parison is approximately 20% of the thickness of the parison.

8. The method of claim 7, wherein the middle layer of the parison is approximately 70% of the thickness of the parison.

9. The method of claim 8, wherein the inner layer of the parison is approximately 10% of the thickness of the parison.

10. A parison supplying apparatus for use with a blow mold machine for producing blow molded containers, the apparatus comprising:
an extrusion head for forming a multi-layered parison;
a first extruder for supplying exclusively a first material to the extrusion head, the first material being for forming a portion of the parison; and
a second extruder for supplying a second material to the extrusion head, the second material being for forming a portion of the parison,
wherein the extrusion head forms the parison in a tubular shape with an outer layer of the first material, a middle layer of the second material and an inner layer of the first material, and
the first material has a lower tendency to adhere to parts of the blow mold machine than does the second material.

11. The apparatus of claim 10, wherein the first material and the second material are polyolefin.

12. The apparatus of claim 11, wherein the first material is virgin material and the second material is recycled material.

13. The apparatus of claim 12, wherein the outer layer of the parison is approximately 20% of the thickness of the parison, the middle layer of the parison is approximately 70% of the thickness of the parison, and the inner layer of the parison is approximately 10% of the thickness of the parison.

14. The apparatus of claim 10, wherein the first extruder has a smaller production rate than the second extruder.

15. The apparatus of claim 14, wherein the first extruder is a 3.5 inch extruder and the second extruder is a 6 inch extruder.

16. The apparatus of claim 10, wherein the outer layer of the parison is approximately 20% of the thickness of the parison.

17. The apparatus of claim 16, wherein the middle layer of the parison is approximately 70% of the thickness of the parison.

18. The apparatus of claim 17, wherein the inner layer of the parison is approximately 10% of the thickness of the parison.

19. A blow mold machine for producing blow molded containers, the machine comprising:
an extrusion head for forming a multi-layered parison;
a first extruder for supplying exclusively a first material to the extrusion head, the first material being for forming a portion of the parison;
a second extruder for supplying a second material to the extrusion head, the second material being for forming a portion of the parison; and
a plurality of molds for forming the containers from the parison,
wherein the extrusion head forms the parison in a tubular shape with an outer layer of the first material, a middle layer of the second material and an inner layer of the first material, and
the first material has a lower tendency to adhere to parts of the blow mold machine than does the second material.

20. The machine of claim 19, wherein the first material and the second material are polyolefin.

21. The machine of claim 20, wherein the first material is virgin material and the second material is recycled material.

22. The machine of claim 21, wherein the outer layer of the parison is approximately 20% of the thickness of the parison, the middle layer of the parison is approximately 70% of the thickness of the parison, and the inner layer of the parison is approximately 10% of the thickness of the parison.

23. The machine of claim 19, wherein the first extruder has a smaller production rate than the second extruder.

24. The machine of claim 23, wherein the first extruder is a 3.5 inch extruder and the second extruder is a 6 inch extruder.

25. The machine of claim 19, wherein the outer layer of the parison is approximately 20% of the thickness of the parison.

26. The machine of claim 25, wherein the middle layer of the parison is approximately 70% of the thickness of the parison.

27. The machine of claim 26, wherein the inner layer of the parison is approximately 10% of the thickness of the parison.
